(19) United States
(12) Patent Application Publication
(10) Pub. No.: US 2026/0338092 A1
(43) Pub. Date: Oct. 29, 2026

(54) CRANKCASE DOOR

(71) Applicant: INNIO Jenbacher GmbH & Co OG, Jenbach (AT)

(72) Inventors: Lorne Nix, Waukesha, WI (US); Peter Holzhammer, Absam (AT); Florian Becker, Muenster (AT)

(21) Appl. No.: 19/115,229

(22) PCT Filed: Sep. 26, 2022
(86) PCT No.: PCT/AT2022/060319

§ 371 Date: Mar. 25, 2025

(51) Int. Cl. F01M 13/04

(52) U.S. Cl. CPC F01M 13/04

(57) ABSTRACT

Crankcase door for covering an opening (3) of a crankcase (2) of an internal combustion engine (4), wherein the crankcase door (1) comprises a base body (5) having an inner surface (6) which faces the interior of the crankcase (2) in a assembled state of the crankcase door (1), wherein the crankcase door (2) comprises at least one absorber element (8), which is arranged at the inner surface (6) of the base body (5).

### CROSS-REFERENCE TO RELATED APPLICATION

This application is a National Stage entry from, and claims benefit of, PCT Application No. PCT/AT2022/060319, filed on Sep. 26, 2022, entitled “CRANKCASE DOOR”, which is herein incorporated by reference in its entirety.

### BACKGROUND

The present invention relates to a crankcase door for covering an opening of a crankcase of an internal combustion engine and an internal combustion engine comprising such a crankcase door.

Typically known crankcases of large internal combustion engines, such as internal combustion engines combusting natural gas, stationary internal combustion engines, internal combustion engines used in gensets, power plants and/or ships, comprise openings in the crankcase.

Such openings in the crankcase of internal combustion engines allow assembly, disassembly, observation, maintenance work and/or inspection work of components, as well as processes inside the crankcase without time-consuming disassembly of many components of the internal combustion engine.

The openings of the crankcase are typically covered by crankcase doors.

Crankcase doors known by the state of the art typically comprise a plate-shaped base body formed by sheet metal or a casting process, removably screwed with the crankcase.

The assembly elements of such crankcase doors are affected by loads and requirements to guarantee a safe operation of the internal combustion engine (e.g., they have to withstand a pressure below ambient pressure which is generated inside the crankcase and create a sealing against the environment regarding blow-by gases and oil).

Such requirements are the result of acting vibrations and thermal effects of the internal combustion engine acting inside the crankcase during operation.

Furthermore, it is commonly known that deflagration events or uncontrolled thermal events can occur inside the crankcase, wherein the crankcase door has to be sufficiently secured at the crankcase, so that it is not separated from the opening of the crankcase by the pressure impulse or pressure wave.

Such a crankcase door is known in the state of the art, e.g., from WO 2012/140313 A1.

A problem with the state of the art is that, if the internal combustion engine has a technical fault (e.g., because of an operator error or the like) individual components can break and/or separate, such that especially moving parts of the internal combustion engine can present a kinetic hazard.

If, e.g., parts arranged in the crankcase (as the crankcase, pistons, piston pins, crankcase bearings, connecting rods or connections of the connecting rods) become unconstrained, these parts or elements of these parts can become projectiles if they lose their connection.

Such elements—in case of emergency—are impacted against the inside walls of the crankcase and the crankcase door, wherein it can happen that the crankcase door is separated from the crankcase, which can represent a threat of collateral damage to property or persons surrounding the internal combustion engine.

### BRIEF DESCRIPTION

One aspect of the present invention is therefore to provide a crankcase door at least partially improving the previously named disadvantages of the state of the art and/or providing the operator or the environment of the internal combustion engine with a higher safety during operation of the internal combustion engine.

This aspect is achieved, according to embodiments of the present invention, with a crankcase door for covering an opening of a crankcase of an internal combustion engine and an internal combustion engine having such a crankcase door.

According to embodiments of the invention, it is provided that a crankcase door for covering an opening of a crankcase of an internal combustion engine comprises a base body having an inner surface which faces the interior of the crankcase in an assembled state of the crankcase door, wherein the crankcase door comprises at least one absorber element, which is arranged at the inner surface of the base body.

By use of at least one absorber element, which is arranged at the inner surface of the base body, in an emergency case during a break down of the internal combustion engine, components hitting the inner surface can be decelerated, wherein a kinetic energy of such components can be absorbed by the at least one absorber element.

As kinetic energy of components hitting the inner surface can be absorbed by the at least one absorber element, the risk can be minimized that these components leave the inside of the crankcase by breaking through the crankcase door or breaking out the crankcase door by damaging the assembled of the crankcase door at the crankcase.

In this way, an operator, persons near to the internal combustion engine, and the environment of the internal combustion engine can be safe also during such an emergency.

Already present internal combustion engines can be upgraded with at least one crankcase door according to embodiments of the invention.

All measures and features described in connection with the prior art can also be taken in connection with embodiments of the invention.

Advantageous embodiments are defined in the claims.

It can be provided that the crankcase door comprises
the inner surface which faces the interior of the crankcase in an assembled state of the crankcase door, and
an outer surface which faces the environment of the crankcase in an assembled state of preferably wherein the inner surface and the outer surface are arranged on opposite sides of the base body.

It can be provided that the at least one absorber element comprises an energy absorbing structure and/or energy absorbing material, wherein a kinetic energy of objects impacting the inner surface can be absorbed by an at least partial deformation of the at least one absorber element, preferably wherein the at least partial deformation is at least partially a plastic deformation.

It can be provided that the absorbing structure is detachable and can be exchanged, replaced or assembled at already existing systems.

For a person skilled in the art, it is clear, that for the most materials plastic deformation occurs just after an elastic deformation in the case the energy causing the deformation is high enough. The strength of a potential mechanical impact which should be absorbed by a crankcase door according to embodiments of the invention generally results in a plastic deformation of the absorbing structure.

Deformation of most materials begins in an elastic range up to the yield point where plastic deformation can take up the bulk of the absorption, up to the ultimate tensile strength of the material. Thereafter, energy absorption takes the form of conservation of energy of the absorbing structure and the impacting bodies.

It can be provided that the at least one absorber element comprises a deformation zone, wherein the deformation zone is capable of absorbing suddenly occurring forces by a deformation, preferably a plastic deformation.

By providing a deformation zone, it can be provided that by use of special materials or structures the capability of a deformation can be increased, wherein the capability of receiving kinetic energy and absorbing kinetic energy can be increased.

It can be provided that the at least one absorber element comprises a sheet material, preferably a sheet metal, in standing configuration on the inner surface, in particular extending a right angle relative to the inner surface.

It can be provided that the sheet material encloses cells, preferably by a corresponding geometry of the sheet metal manufactured by bending and/or joining the sheet material with another sheet material.

It can be provided that the cells enclose hexagonal areas seen in a cross section of the cells. Cells with other base areas, such as rectangular, elliptic, or in general polygonal or round, are of course conceivable.

It can be provided that the absorber element comprises a honeycomb structure.

It can be provided that the least one absorber element faces the interior of the crankcase in an assembled state of the crankcase door.

It can be provided that the at least one absorber element contains a plastic, preferably a composite material, an aluminum and/or an aluminum alloy. Furthermore, the application of other materials having an increased deformation properties and/or increased yield points are conceivable.

It can be provided that the at least one absorber element is assembled to the base body of the crankcase door by a bolt and/or threaded connection.

It can be provided that at least one mounting plate is provided, wherein the at least one absorber element is arranged at the inner surface between the base body and the mounting plate, and preferably is assembled between the base body and the mounting plate by a bolt and/or threaded connection.

It can be provided that the at least one absorber element is formed as one piece with the base body of the crankcase door and/or is connected with the base body of the crankcase door by a positive lock connection and/or adhesive bonding.

It can be provided that the base body is essentially flat for covering the opening, preferably comprising a thickness of 5 -25 mm.

It can be provided that the base body is made by casting and/or formed at least partially by a sheet metal material.

It can be provided that at least one pressure relief valve and/or a burst disk is provided.

During operation of the internal combustion engine, bypass gases comprising flammable air-gas-mixtures pass from the combustion chambers into the crankcase.

These gases could in some cases deflagrate or explode inside the crankcase, wherein by use of a pressure relief valve and/or a burst disk, overpressures caused by such events can be discharged.

It can be provided that the pressure relief valve and/or the burst disk is fixed at the base body, wherein transfer channels of the base body fluidly connect the interior of the crankcase with the pressure relief valve and/or the burst disk.

It can be provided that a valve element of the pressure relief valve is preloaded, preferably by a spring, with respect to base body, wherein at a defined pressure in the crankcase the valve element releases a fluid connection between the interior of the crankcase and the environment.

It can be provided that the base body comprises a mounting portion, wherein the crankcase door is attachable to the crankcase at the mounting portion, and preferably wherein the mounting portion essentially comprises a form of the opening of the crankcase covered by the crankcase door.

It can be provided that the crankcase door is assembled—especially in the region of the mounting position—by a positive lock connection and/or a clamp connection and/or a threaded connection, to a crankcase of an internal combustion engine.

### BRIEF DESCRIPTION OF THE DRAWINGS

Further details and advantages of the invention are apparent from the accompanying figures and the following description of the drawings. The figures show:

FIGS. 1 and 2 illustrate a first embodiment of an internal combustion engine comprising a crankcase door,

FIGS. 2a-2c illustrate a first embodiment of a crankcase door,

FIGS. 3a-3c illustrate a second embodiment of a crankcase door,

FIGS. 4a-4d illustrate a third embodiment of a crankcase door, and

FIG. 5 illustrates a second embodiment of an internal combustion engine comprising a crankcase door.

### DETAILED DESCRIPTION

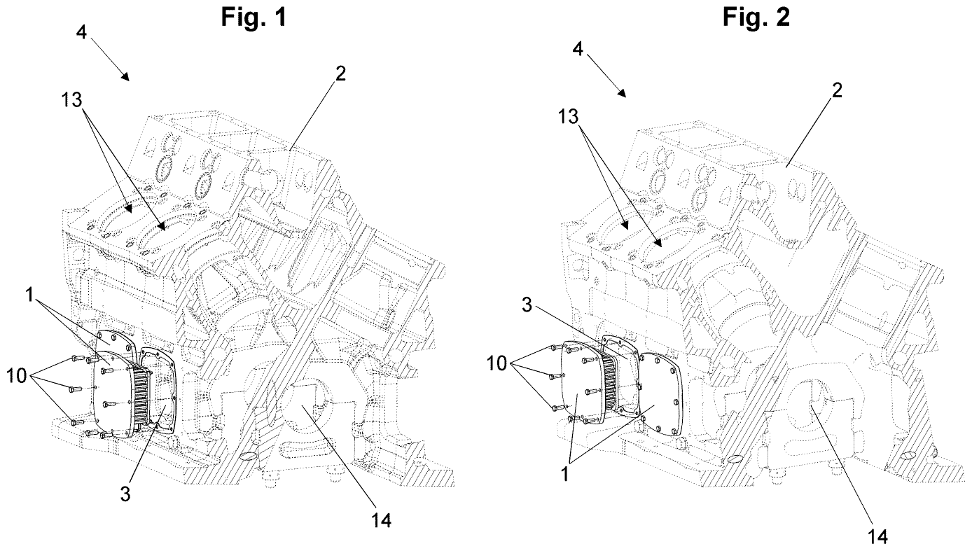

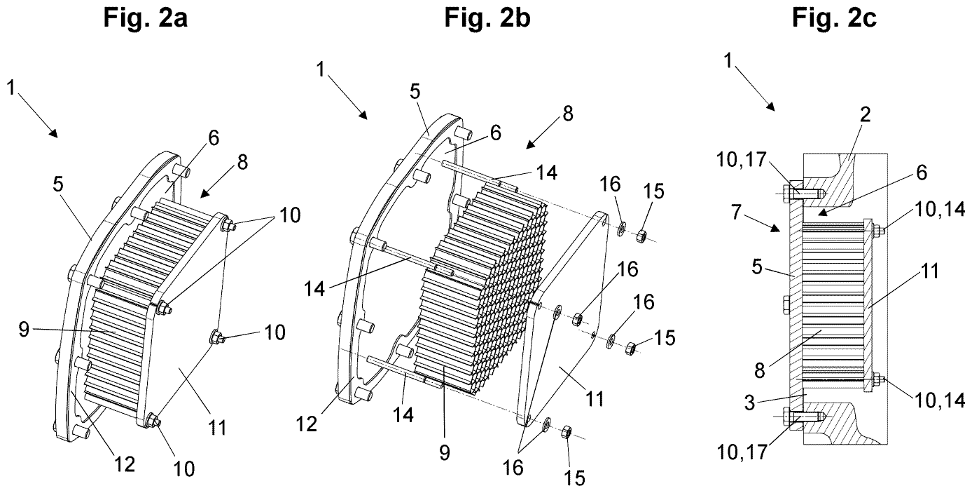

FIG. 1 and FIG. 2 depicts an internal combustion engine 4 comprising a crankcase 2.

The crankcase 2 is provided with cylinder bores 13 for receiving piston-cylinder-units (for reasons of clarity not shown).

The pistons of the piston-cylinder-units are assembled by connecting rods with a crankshaft which protrudes through the crankshaft opening 14 of the crankcase 2 (also not shown for reasons of clarity).

For internal combustion engines 4 as shown by FIG. 1 and FIG. 2 having greater dimensions (beginning with about 3 litres cylinder capacity, such as internal combustion engines 4 used at power plants for producing electricity), it is well known to provide the crankcase 2 with openings 3.

These openings 3 of the crankcase 2 are used to assemble, disassemble, for observation, maintenance work and/or inspection work of components arranged inside the crankcase 2.

As these openings 3 cannot be left open during operation of the internal combustion engine 4, the openings 3 are closed by so called crankcase doors 1.

The crankcase door 1 is intended for covering the opening 3 in the crankcase 2.

As can be seen by FIG. 1 and FIG. 2, an internal combustion engine 4 can comprise more than one crankcase door 1, preferably one crankcase door 1 per piston-cylinder-unit.

Also, the dimensions of such a crankcase door 1 can vary depending on the size of the internal combustion engine 4, beginning with a size of some square centimeters up to and larger than a square meter.

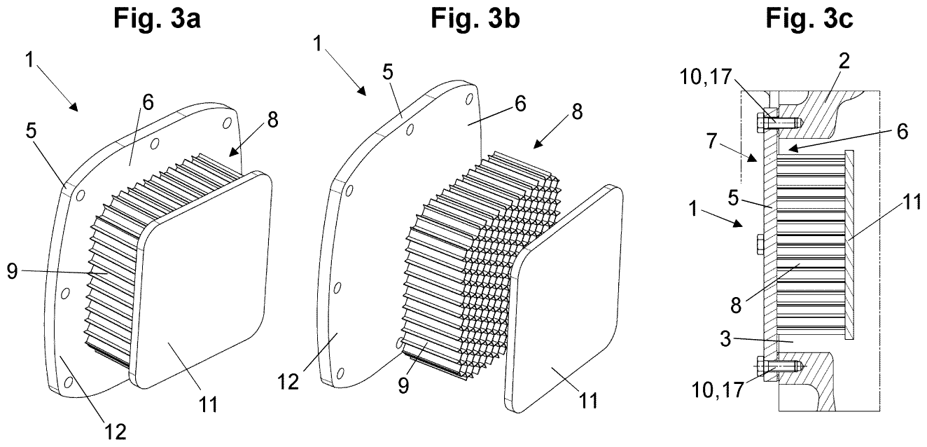

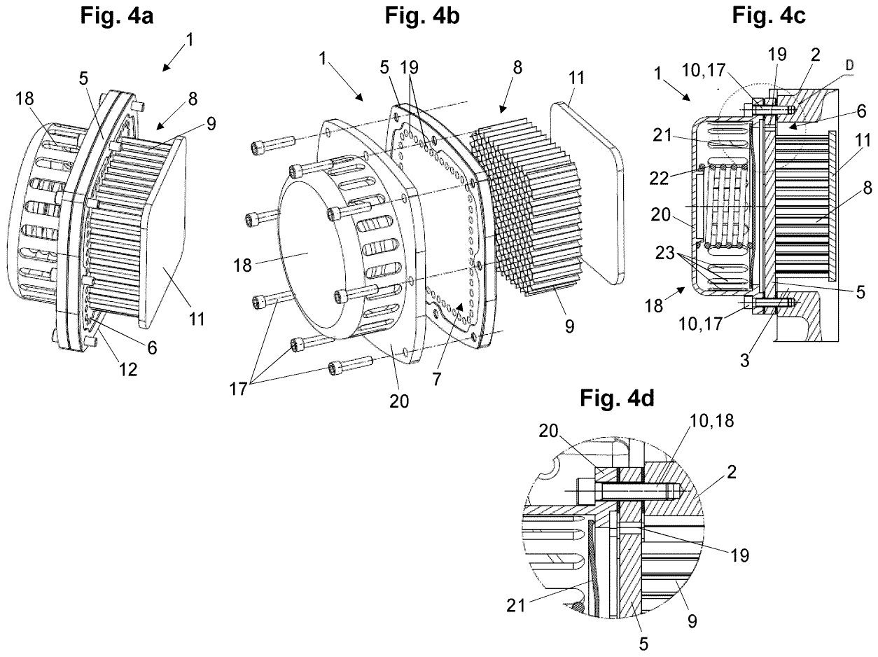

The crankcase door 1 shown by FIG. 1 and FIG. 2 are assembled at the crankcase 2 by threaded connections 10 fastened at the mounting portion 12 of the base body 5 of the crankcase door 1 (will be later discussed in more detail referring to FIG. 3 and FIG. 4).

In the embodiment shown by FIG. 1 and FIG. 2, the crankcase door 1 is provided with a rectangular flat form, wherein the shape of the crankcase door 1 circumference is matched to the shape of the opening 3 to cover the whole opening 3.

The shape of the crankcase door 1 can of course vary depending on the shape of the opening 3 of the internal combustion engine 4, wherein the opening 3 in most cases is matched to the type of the internal combustion engine 4.

FIG. 2a to 2c discloses a first embodiment of a crankcase door 1 according to the present invention, wherein
FIG. 2a shows an assembled state of the crankcase door 1,
FIG. 2b an exploded view of the assembly of FIG. 2a, and
FIG. 2c an assembled state of the embodiment of FIG. 2a and FIG. 2b at the crankcase 2 of the internal combustion engine 4.

The embodiment of the crankcase door 1 shown by FIG. 2a to FIG. 2c comprise a base body 5.

The base body 5 comprises an inner surface 6 which faces the interior of the crankcase 2 in an assembled state of the crankcase door 1.

Opposite of the inner surface 6 of the base body 5 the outer surface 7 is arranged which faces the environment of the crankcase 2 in an assembled state of the crankcase door 1.

The crank case door 1 can be assembled (as can be seen in FIG. 2c) at the crankcase 2 by a threaded connection 10, wherein the base body 5 with its mounting portion 12 is in contact with the crankcase 2 and is assembled by the screws 17 to cover the opening 3 of the crankcase 2.

The base body 5 is formed in this embodiment by casting having a flat structure between the inner surface 6 and the outer surface 7.

Between the mounting portion 12 and the crankcase 2, a sealing can be arranged, wherein by the threaded connection 10 using the screws 17 the sealing can be fixed for sealing the interior of the crankcase 2 with respect to the environment.

At the inner surface 6 of the base body 5 of the crankcase door 1, the absorber element 8 is assembled, which absorber element 8 comprises a honeycomb structure 9, wherein a kinetic energy of objects impacting the inner surface or the absorber element 8 can be absorbed by at least partial deformation of the honeycomb structure 9, preferably wherein the at least partial deformation is at least partially a plastic deformation.

The honeycomb structure 9 is provided by sheet material in standing configuration on the inner surface, extending a right angle relative to the inner surface 6.

This sheet material of the honeycomb structure 9 is built up by a plurality of sheet materials interlinked with each other and enclose hexagonal areas seen in a cross section of the honeycomb structure 9.

The honeycomb structure 9 can be manufactured by an energy absorbing material (as, e.g., plastic, a composite material, an aluminum and/or an aluminum alloy).

The absorber element 8 is assembled to the base body 5 of the crankcase door 1 by a threaded connection 10 using threaded bolts 15 and nuts 16.

The threaded bolts 15 are assembled at the first end in the base body 5. At the other (second) end, the threaded bolts 15 comprise a thread, which extend through holes of the mounting plate 11.

The second end of the threaded bolts 15 is screwed with nuts 16 and washers 17 to fix the absorber element 8 at the inner surface 6 of the base body 5 via the mounting plate 11.

In particular, the absorber element 8 is clamped between the base body 5 and the mounting plate 11.

FIG. 3a to 3c discloses a second embodiment of a crankcase door 1 according to the present invention, wherein
FIG. 3a shows an assembled state of the crankcase door 1,
FIG. 3b an exploded view of the assembly of FIG. 3a, and
FIG. 3c an assembled state of the embodiment of FIG. 3a and FIG. 3b at the crankcase 2 of the internal combustion engine 4.

Compared to the first embodiment of FIG. 2a to FIG. 2c, the second embodiment of FIG. 3a to FIG. 3c has the base body 5, the absorber element 8 and the mounting plate 11 fixed to each other by an adhesive bonding joint instead of the threaded connection 10.

The remaining features of the embodiments of FIG. 2a to FIG. 2c and FIG. 3a to FIG. 3c are essentially the same.

FIG. 4a to FIG. 4d depicts a third embodiment of a crankcase door 1 according to the present invention, wherein
FIG. 4a shows an assembled state of the crankcase door 1,
FIG. 4b shows an exploded view of the assembly of FIG. 4a,
FIG. 4c shows an assembled state of the embodiment of FIG. 4a and FIG. 4b at the crankcase 2 of the internal combustion engine 4, and
FIG. 4 d shows the detail D identified in FIG. 4 c.

The third embodiment depicted by FIG. 4a to FIG. 4d essentially corresponds with the second embodiment shown by FIG. 3a to FIG. 3c, but additionally comprises a pressure relief valve 18.

In the embodiment shown by FIG. 4a to FIG. 4d, a pressure relief valve 18 is assembled at the outer surface 7 of the base body 5.

In particular, the pressure relief valve 18 covers the outer surface 7 of the base body 5 by the pressure relief valve base body 20.

The pressure relief valve 18 is fixed at the base body 5 by the threaded connection 10 using the screws 17, wherein the pressure relief valve 18 is screwed together with the base body 5 at the crankcase 2.

Between the pressure relief valve base body 20 and the base body 5, a sealing can be arranged, wherein by the threaded connection 10 (the screws 17) the sealing can be fixed for sealing the interior of the pressure relief valve 18 with respect to the environment.

The base body 5 of the crankcase door 1 of this embodiment comprises transfer channels 19.

The transfer channels 19 of the base body 5 fluidly connect the interior of the crankcase 2 with the interior of the pressure relief valve 18.

The pressure relief valve 18 comprises a valve element 21, which valve element 21 is spring preloaded with respect to the spring pressure relief valve base body 20.

The preloaded valve element 21 separates the interior of the pressure relief valve 18 (and therefore the interior of the crankcase 2) from the environment of the internal combustion engine 4.

The interior of the pressure relief valve 18 is the volume between the valve element 21 in a closed state of the pressure relief valve 18 and the interior of the crankcase 2 in a fluid communication sense.

If the pressure inside the crankcase rises (e.g., because of a deflagration of bypass gases inside the crankcase), then the gases can pass through the transfer channels 19 of the base body 5.

The preloaded valve element 21 can be pressed in a direction facing away from the opening 3 by the rising pressure, wherein a flow through of the gas from the crankcase 2 is enabled passing the transfer channels 19, the valve element 21 and the ventilation elements 23 into the environment of the internal combustion engine 4.

By use of such a pressure relief valve 18, a pressure compensation of the interior of the crankcase 2 is allowed if the pressure inside the crankcase 2 rises (if, e.g., an explosion takes place inside the crankcase 2) to ensure that the crankcase 2 is not damaged by the elevated pressure.

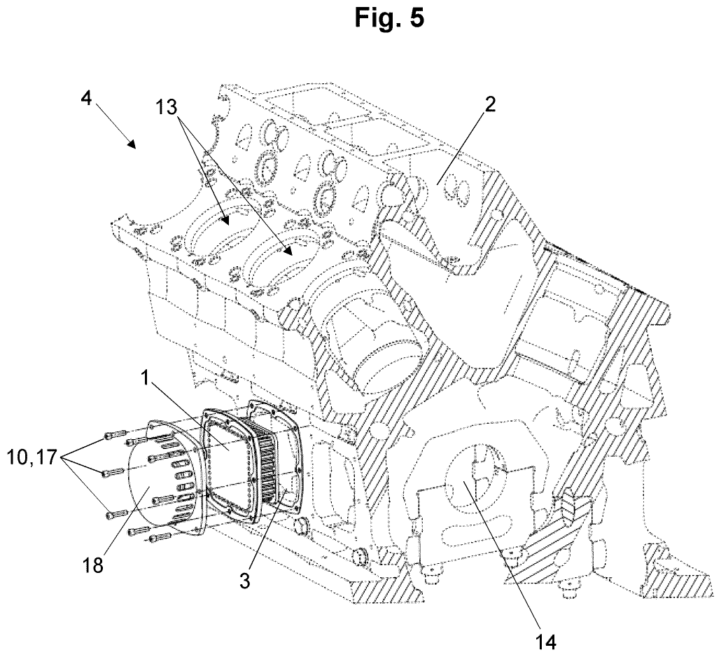

FIG. 5 shows an embodiment of an internal combustion engine 4 having a crankcase 2 and a crankcase door 1 according to FIG. 4a to FIG. 4d.

### LIST OF USED REFERENCE SIGNS

1. Crankcase door
2. Crankcase
3. Opening of the crankcase
4. Internal combustion engine
5. Base body
6. Inner surface
7. Outer surface
8. Absorber element
9. Honeycomb structure
10. Threaded connection
11. Mounting plate
12. Cylinder bore
13. Crankshaft opening
14. Threaded bolt
15. Nut
16. Washer
17. Screw
18. Pressure relief valve
19. Transfer channel
20. Pressure relief valve base body
21. Valve element
22. Spring
23. Ventilation hole

1. A system, comprising:
a crankcase door configured to cover an opening of a crankcase of an internal combustion engine, wherein the crankcase door comprises:
a base body having an inner surface configured to face an interior of the crankcase in an assembled state of the crankcase door; and
at least one absorber element arranged at the inner surface of the base body.

2. The system according to claim 1, wherein the at least one absorber element comprises an energy absorbing structure and/or an energy absorbing material, wherein a kinetic energy of objects impacting the inner surface is absorbed by an at least partial deformation of the at least one absorber element, wherein the at least partial deformation is at least partially a plastic deformation.

3. The system according to claim 1, wherein the at least one absorber element comprises a deformation zone, wherein the deformation zone is configured to absorb suddenly occurring forces by a deformation.

4. The system according to claim 1, wherein the at least one absorber element comprises a sheet material in a standing configuration on the inner surface extending at a right angle relative to the inner surface.

5. The system according to claim 4, wherein the sheet material encloses a plurality of cells,

6. The system according to claim 5, wherein the plurality of cells enclose hexagonal areas in a cross section of the plurality of cells.

7. The system according to claim 1, wherein the at least one absorber element comprises a honeycomb structure.

8. The system according to claim 1, wherein the least one absorber element is configured to face the interior of the crankcase in an assembled state of the crankcase door.

9. The system according to claim 1, wherein the at least one absorber element comprises a plastic material, a composite material, an aluminum, and/or an aluminum alloy.

10. The system according to claim 1, wherein the at least one absorber element is assembled to the base body of the crankcase door by a bolt and/or a threaded connection.

11. The system according to claim 1, comprising at least one mounting plate, wherein the at least one absorber element is arranged at the inner surface between the base body and the mounting plate.

12. The system according to claim 1, wherein the at least one absorber element is formed as one piece with the base body of the crankcase door and/or is connected with the base body of the crankcase door by a positive lock connection and/or an adhesive bonding.

13. The system according to claim 1, wherein the base body is essentially flat for covering the opening, and the base body has a thickness of 5 -25 mm.

14. The system according to claim 1, wherein the base body is made by casting and/or formed at least partially by a sheet metal material.

15. The system according to claim 1, wherein the crankcase door comprises at least one pressure relief valve and/or a burst disk.

16. The system according to claim 15, wherein the pressure relief valve and/or the burst disk is fixed at the base body, wherein transfer channels of the base body fluidly connect the interior of the crankcase with the pressure relief valve and/or the burst disk.

17. The system according to claim 16, wherein a valve element of the pressure relief valve is preloaded by a spring, with respect to the base body, wherein at a defined pressure in the crankcase the valve element opens a fluid connection between the interior of the crankcase and the environment.

18. The system according to claim 1, wherein the base body comprises a mounting portion, wherein the crankcase door is attachable to the crankcase at the mounting portion, and wherein the mounting portion comprises a form of the opening of the crankcase covered by the crankcase door.

19. The system according to claim 1, comprising the internal combustion engine having the crankcase and the opening, wherein the opening is at least partially covered by the crankcase door.

20. A method, comprising:
covering an opening of a crankcase of an internal combustion engine with a crankcase door, wherein the crankcase door comprises a base body having an inner surface configured to face an interior of the crankcase in an assembled state of the crankcase door, and at least one absorber element arranged at the inner surface of the base body.
